(19) United States
(12) Patent Application Publication
(10) Pub. No.: US 2026/0010024 A1
(43) Pub. Date: Jan. 8, 2026

(54) DISPLAY APPARATUS

(71) Applicant: Coretronic Corporation, Hsin-Chu (TW)

(72) Inventors: Wen-Chang Wen, Hsin-Chu (TW); Jing-Yu Wu, Hsin-Chu (TW); Ching-Tai Tseng, Hsin-Chu (TW); Ping-Yen Chen, Hsin-Chu (TW); Chung-Yang Fang, Hsin-Chu (TW)

(73) Assignee: Coretronic Corporation, Hsin-Chu (TW)

(21) Appl. No.: 19/239,858

(22) Filed: Jun. 16, 2025

(30) Foreign Application Priority Data
Jul. 5, 2024 (CN) 202421577351.4

(51) Int. Cl. G02F 1/13; G02F 1/1333; G02F 1/1335; G02F 1/1347

(52) U.S. Cl. CPC G02F 1/1323; G02F 1/133302; G02F 1/133528; G02F 1/1347; G02F 2201/50

(57) ABSTRACT

A display apparatus including a display panel and an anti-peep module is provided. The anti-peep module is disposed on one side of a display surface of the display panel and overlaps the display surface. The anti-peep module includes a first polarizer, a first substrate, a first liquid crystal layer, a second substrate, a second polarizer, a third substrate, a second liquid crystal layer, a fourth substrate and a third polarizer sequentially arranged on the display surface of the display panel. The first polarizer is disposed between the first substrate and the display panel. The second polarizer is disposed between the second substrate and the third substrate. The third polarizer is disposed on one side of the fourth substrate facing away from the third substrate. At least two of the first substrate, the second substrate, the third substrate and the fourth substrate each have birefringence.

### CROSS-REFERENCE TO RELATED APPLICATION

This application claims the priority benefit of China application serial no. 202421577351.4, filed on Jul. 5, 2024. The entirety of the above-mentioned patent application is hereby incorporated by reference herein and made a part of this specification.

### BACKGROUND

### Technical Field

The disclosure relates to a display apparatus, and more particularly, to a display apparatus with anti-peep function.

### Description of Related Art

Currently, most electronic privacy sheets use glass substrates, and additional polarizers are typically required on both sides of the privacy sheet. To achieve better anti-peep effect, anti-peep modules generally employ two sets of electronic privacy sheets. As a result, the overall thickness and weight of the display apparats significantly increase due to the extra electronic privacy sheet, leading to poor applicability in portable products.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one, a part, or all of the above objectives or other objectives, an embodiment of the disclosure provides a display apparatus. The display apparatus includes a display panel and an anti-peep module. The display panel has a display surface. The anti-peep module is disposed on one side of the display surface of the display panel and overlaps the display surface. The anti-peep module includes a first substrate, a second substrate, a third substrate, a fourth substrate, a first liquid crystal layer, a second liquid crystal layer, a first polarizer, a second polarizer and a third polarizer. The first substrate, the second substrate, the third substrate and the fourth substrate are overlapped with each other. The first liquid crystal layer is disposed between the first substrate and the second substrate. The second liquid crystal layer is disposed between the third substrate and the fourth substrate. The first polarizer is disposed between the first substrate and the display panel. The second polarizer is disposed between the second substrate and the third substrate. The third polarizer is disposed on one side of the fourth substrate facing away from the third substrate. At least two of the first substrate, the second substrate, the third substrate and the fourth substrate each have birefringence.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display apparatus according to a first embodiment of the disclosure.

FIG. 2A shows distribution curves of transmittance versus viewing angle for the display apparatus in FIG. 1 operating in a sharing mode and an anti-peep mode.

FIG. 2B shows distribution curves of transmittance versus viewing angle for a display apparatus of a comparative example operating in a sharing mode and an anti-peep mode.

FIG. 3 is a schematic cross-sectional view of a display apparatus according to a second embodiment of the disclosure.

FIG. 4 is a schematic cross-sectional view of a display apparatus according to a third embodiment of the disclosure.

FIG. 5 shows distribution curves of transmittance versus viewing angle for the display apparatus in FIG. 4 operating in a sharing mode and an anti-peep mode.

FIG. 6 is a schematic cross-sectional view of a display apparatus according to a fourth embodiment of the disclosure.

FIG. 7 is a schematic cross-sectional view of a display apparatus according to a fifth embodiment of the disclosure.

FIG. 8 is a schematic cross-sectional view of another modified embodiment of the display apparatus of FIG. 7.

FIG. 9 is a schematic cross-sectional view of a display apparatus according to a sixth embodiment of the disclosure.

FIG. 10 shows distribution curves of transmittance versus viewing angle for the display apparatus in FIG. 9 operating in a sharing mode and an anti-peep mode.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

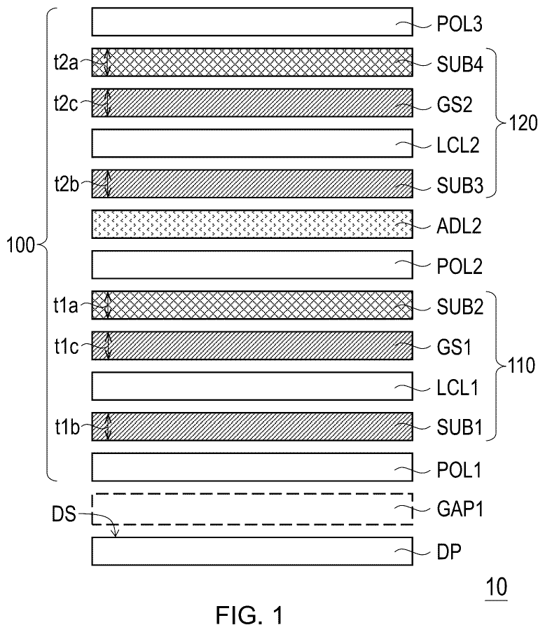

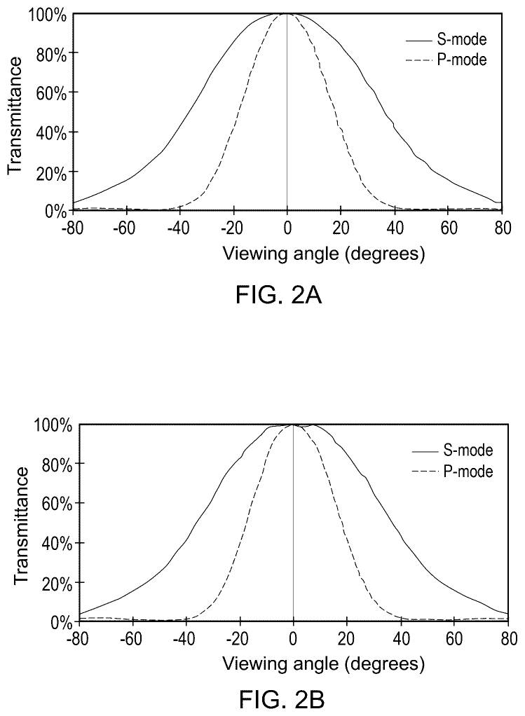

FIG. 1 is a schematic cross-sectional view of a display apparatus according to a first embodiment of the disclosure. FIG. 2A shows distribution curves of transmittance versus viewing angle for the display apparatus in FIG. 1 operating in a sharing mode and an anti-peep mode. FIG. 2B shows distribution curves of transmittance versus viewing angle for a display apparatus of a comparative example operating in a sharing mode and an anti-peep mode.

Referring to FIG. 1, A display apparatus 10 includes a display panel DP and an anti-peep

module 100. The display panel DP has a display surface DS. The anti-peep module 100 is disposed on one side of the display surface DS of the display panel DP and overlaps the display surface DS. The display panel DP is, for example, an organic light emitting diode (OLED) display panel, a micro light emitting diode (micro-LED) display panel, a mini light emitting diode (mini-LED) display panel, or other suitable self-emissive display panel. However, the disclosure is not limited thereto. In some embodiments, the display panel DP may also be a liquid crystal display panel, or other suitable non-emissive display panel.

In the embodiment, the display apparatus 10 is suitable for operating in an anti-peep mode and a sharing mode. It should be noted first that when the light emission angle range of the anti-peep module 100 is switched to a wide-angle range, the display apparatus 10 operates in the sharing mode with a larger viewing angle range. When the light emission angle range of the anti-peep module 100 is switched to a narrow-angle range, the display apparatus 10 operates in the anti-peep mode with a smaller viewing angle range.

In detail, the anti-peep module 100 includes a first substrate SUB1, a second substrate SUB2, a third substrate SUB3, a fourth substrate SUB4, a first liquid crystal layer LCL1, a second liquid crystal layer LCL2, a first polarizer POL1, a second polarizer POL2 and a third polarizer POL3 arranged overlapping each other. The first liquid crystal layer LCL1 is disposed between the first substrate SUB1 and the second substrate SUB2. The second liquid crystal layer LCL2 is disposed between the third substrate SUB3 and the fourth substrate SUB4. The first polarizer POL1 is disposed between the display panel DP and the first substrate SUB1. The second polarizer POL2 is disposed between the second substrate SUB2 and the third substrate SUB3. The third polarizer POL3 is disposed on one side of the fourth substrate SUB4 facing away from the third substrate SUB3.

From another point of view, the first substrate SUB1, the second substrate SUB2 and the first liquid crystal layer LCL1 may constitute a first viewing angle switching device 110 of the anti-peep module 100, while the third substrate SUB3, the fourth substrate SUB4 and the second liquid crystal layer LCL2 may constitute a second viewing angle switching device 120 of the anti-peep module 100. The first polarizer POL1 is located between the first viewing angle switching device 110 and the display panel DP. The second polarizer POL2 is located between the first viewing angle switching device 110 and the second viewing angle switching device 120. The third polarizer POL3 is located on one side of the second viewing angle switching device 120 facing away from the first viewing angle switching device 110.

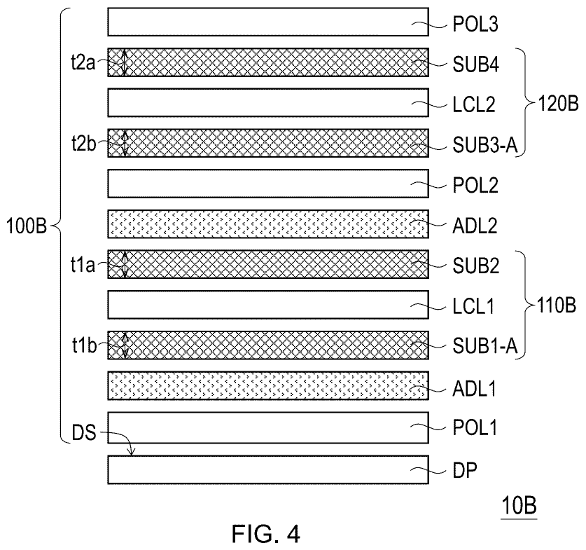

In the embodiment, the first viewing angle switching device 110 and the second viewing angle switching device 120 are bonded to each other, for example, in a direct bond manner and the anti-peep module 100 is, for example, fixed to the display panel DP in an air bond manner, but the disclosure is not limited thereto. That is, a first gap GAP1 may be provided between the first viewing angle switching device 110 and the display panel DP, and a second adhesive layer ADL2 may be provided between the first viewing angle switching device 110 and the second viewing angle switching device 120 (The first adhesive layer ADL1 is disclosed in the embodiment of FIG. 4). A material of the second adhesive layer ADL2 includes, for example, optically clear adhesive (OCA) or optically clear resin (OCR), but the disclosure is not limited thereto.

For example, the first polarizer POL1 and the second polarizer POL2 may be respectively attached to side surfaces of the first substrate SUB1 and the second substrate SUB2 of the first viewing angle switching device 110 facing away from the first liquid crystal layer LCL1, and the third polarizer POL3 may be attached to a side surface of the fourth substrate SUB4 of the second viewing angle switching device 120 facing away from the second liquid crystal layer LCL2. In the embodiment, the first polarizer POL1 is, for example, a circular polarizer, and the second polarizer POL2 and the third polarizer POL3 are, for example, linear polarizers, but the disclosure is not limited thereto.

It is particularly noted that materials of at least two of the first substrate SUB1, the second substrate SUB2, the third substrate SUB3 and the fourth substrate SUB4 each have birefringence. For example, in the embodiment, the materials of the first substrate SUB1 and the third substrate SUB3 include glass, and the materials of the second substrate SUB2 and the fourth substrate SUB4 may have birefringence and include tri-acetyl cellulose (TAC), polymethyl methacrylate (PMMA), cyclic olefin polymer (COP) or polycarbonate (PC).

Since the second substrate SUB2 and the fourth substrate SUB4 each have birefringence, they may compensate phase retardation for non-normally incident light, thus further improving the anti-peep effect of the anti-peep module 100.

On the other hand, a thickness t1a of the second substrate SUB2 and a thickness t2a of the fourth substrate SUB4 may each be greater than or equal to 40 microns and less than or equal to 160 microns, for example, 100 microns. Since a substrate made of a birefringent material may be thinner and lighter than a glass substrate, using a birefringent material (such as TAC) to make the second substrate SUB2 and the fourth substrate SUB4 can effectively reduce the overall thickness and weight of the anti-peep module 100.

In the anti-peep module 100 of the embodiment, a first glass substrate GS1 may be provided between the first liquid crystal layer LCL1 and the second substrate SUB2, and a second glass substrate GS2 may be provided between the second liquid crystal layer LCL2 and the fourth substrate SUB4. However, the disclosure is not limited thereto. In another modified embodiment, the second substrate SUB2 and the fourth substrate SUB4 are made of glass while the first substrate SUB1 and the third substrate SUB3 are made of birefringent materials, and then the first glass substrate GS1 may be disposed between the first liquid crystal layer LCL1 and the first substrate SUB1, and the second glass substrate GS2 may be disposed between the second liquid crystal layer LCL2 and the third substrate SUB3.

In order to further thin the anti-peep module 100, a sum of a thickness t1b of the first substrate SUB1 and a thickness t1c of the first glass substrate GS1 and a sum of a thickness t2b of the third substrate SUB3 and a thickness t2c of the second glass substrate GS2 may each be less than or equal to 200 microns. For example, the thickness t1b of the first substrate SUB1 and the thickness t1c of the first glass substrate GS1 may be a combination of 50 microns and 150 microns or a combination of 100 microns and 100 microns, while the thickness t2b of the third substrate SUB3 and the thickness t2c of the second glass substrate GS2 may be a combination of 50 microns and 150 microns or a combination of 100 microns and 100 microns, but the disclosure is not limited thereto.

In a comparative example of an anti-peep module, the stacking structure thereof is similar to the anti-peep module 100 of FIG. 1, but the only difference lies in that the thickness of each of the first substrate SUB1, the third substrate SUB3, the first glass substrate GS1 and the second glass substrate GS2 of the comparative example is 400 microns. FIG. 2A shows the distribution curves of transmittance versus viewing angle of the anti-peep module 100 of the embodiment operating in the sharing mode (S-mode) and the anti-peep mode (P-mode) respectively. FIG. 2B shows the distribution curves of transmittance versus viewing angle of the anti-peep module of the comparative example operating in the sharing mode and the anti-peep mode respectively.

As shown in FIG. 2A and FIG. 2B, the anti-peep performance of the thinned anti-peep module 100 is still equivalent to the anti-peep performance of the anti-peep module of the comparative example (i.e., the thickness is not thinned). In other words, the thinned anti-peep module 100 may still maintain good anti-peep performance.

Furthermore, in order to allow the display apparatus 10 of FIG. 1 to switch between the anti-peep mode and the sharing mode in an electronically controlled manner, two first electrode layers (not shown) may be provided on opposite sides of the first liquid crystal layer LCL1, respectively. A first alignment layer (not shown) may be disposed between the first liquid crystal layer LCL1 and each of the two first electrode layers. Two second electrode layers may be provided on opposite sides of the second liquid crystal layer LCL2, respectively. A second alignment layer may be disposed between the second liquid crystal layer LCL2 and each of the two second electrode layers. In addition, the driving modes of the first liquid crystal layer LCL1 and the second liquid crystal layer LCL2 may be the same or different, and include, for example, a twisted nematic (TN) mode or an electrically controlled birefringence (ECB) mode, but the disclosure is not limited thereto.

Some other embodiments are provided below to describe the invention in detail, where the same reference numerals denote the same or like components, and descriptions of the same technical contents are omitted. The aforementioned embodiment may be referred for descriptions of the omitted parts, and detailed descriptions thereof are not repeated in the following embodiment.

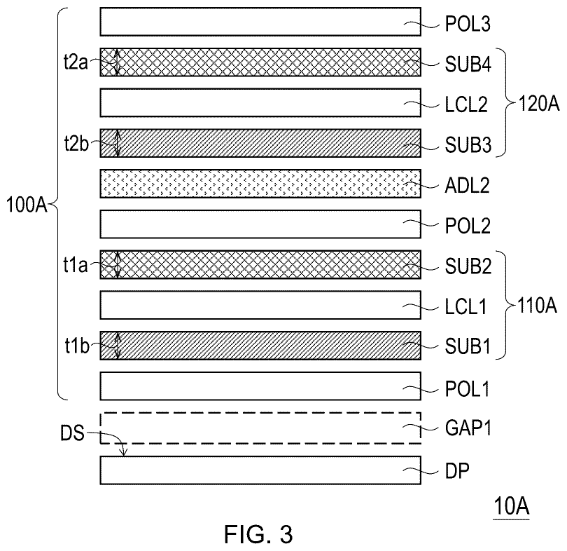

FIG. 3 is a schematic cross-sectional view of a display apparatus according to a second embodiment of the disclosure. Referring to FIG. 3, in a display apparatus 10A of the embodiment, the overall thickness of the anti-peep module 100A may be further thinned compared to the anti-peep module 100 of FIG. 1. For example, in the embodiment, the first viewing angle switching device 110A is not provided with the first glass substrate GS1 of FIG. 1, and the second viewing angle switching device 120A is not provided with the second glass substrate GS2 of FIG. 1. Accordingly, the overall weight and thickness of the anti-peep module 100A may be further reduced.

Preferably, a sum of the thickness t1b of the first substrate SUB1 made of glass and the thickness t1a of the second substrate SUB2 made of birefringent material (e.g., tri-acetyl cellulose) is less than or equal to 200 microns, and a sum of the thickness t2b of the third substrate SUB3 made of glass and the thickness t2a of the fourth substrate SUB4 made of birefringent material (e.g., tri-acetyl cellulose) is less than or equal to 200 microns.

Since other components not mentioned in the anti-peep module 100A of the embodiment are similar to the anti-peep module 100 of FIG. 1, detailed descriptions can be found in the relevant paragraphs of the aforementioned embodiments and will not be repeated here.

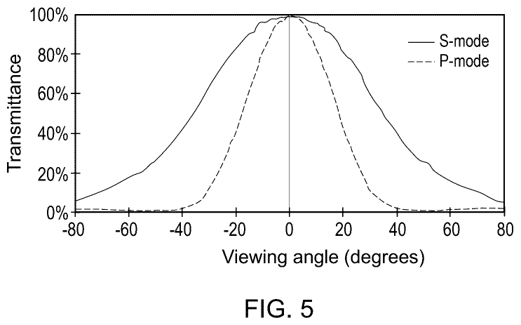

FIG. 4 is a schematic cross-sectional view of a display apparatus according to a third embodiment of the disclosure. FIG. 5 shows distribution curves of transmittance versus viewing angle for the display apparatus in FIG. 4 operating in a sharing mode and an anti-peep mode. Referring to FIG. 4, the main difference between a display apparatus 10B of the embodiment and the display apparatus 10A of FIG. 3 lies in that the materials of the first substrate and the third substrate are different.

Specifically, in the anti-peep module 100B of the embodiment, the first substrate SUB1-A of the first viewing angle switching device 110B and the third substrate SUB3 of the second viewing angle switching device 120B are also made of birefringence materials (e.g., TAC). For example, in the embodiment, the thickness t1b of the first substrate SUB1-A, the thickness t1a of the second substrate SUB2, the thickness t2b of the third substrate SUB3-A, and the thickness t2a of the fourth substrate SUB4 may each be greater than or equal to 20 microns and less than or equal to 80 microns. Accordingly, the overall thickness and weight of the anti-peep module 100B may be further reduced.

FIG. 5 shows the distribution curves of transmittance versus viewing angle of the anti-peep module 100B of the embodiment operating in the sharing mode (S-mode) and the anti-peep mode (P-mode) respectively. As shown in FIG. 2B and FIG. 5, the anti-peep performance of the thinned anti-peep module 100B is still equivalent to the anti-peep performance of the anti-peep module of the comparative example (i.e., the thickness is not thinned). In other words, the thinned anti-peep module 100B may still maintain good anti-peep performance.

On the other hand, in the embodiment, the first polarizer POL1 is, for example, directly attached to the display panel DP, and the anti-peep module 100B and the display panel DP are bonded to each other in a direct bond manner. That is, a first adhesive layer ADL1 may be provided between the first substrate SUB1-A of the anti-peep module 100B and the display panel DP, and the material of the first adhesive layer ADL1 includes, for example, OCA or OCR, but the disclosure is not limited thereto. In addition, in the embodiment, a second adhesive layer ADL 2 is provided between the second substrate SUB2 and the third substrate SUB3-A, and the second adhesive layer ADL 2 is located between the second polarizer POL2 and the second substrate SUB2. That is, the second polarizer POL2 is not directly attached to the second substrate SUB2 of the first viewing angle switching device 110B, but is directly attached to the third substrate SUB3-A of the second viewing angle switching device 120B. The second polarizer POL2 is attached to the second substrate SUB2 of the first viewing angle switching device 110B through the second adhesive layer ADL2.

Since other components not mentioned in the anti-peep module 100B of the embodiment are similar to the anti-peep module 100 of FIG. 1, detailed descriptions can be found in the relevant paragraphs of the aforementioned embodiments and will not be repeated here.

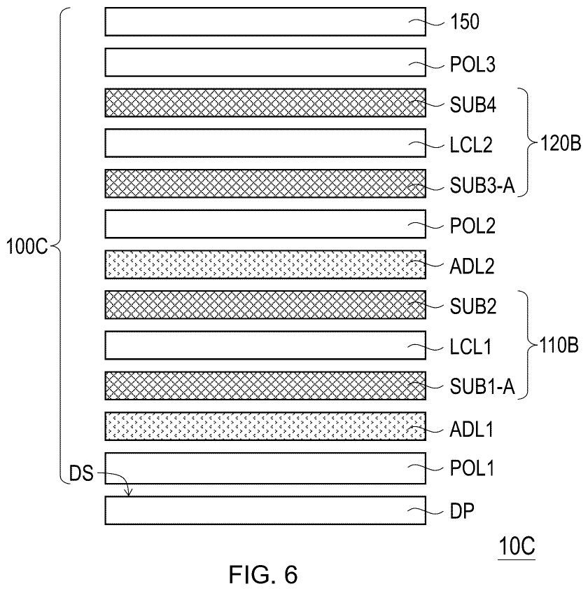

FIG. 6 is a schematic cross-sectional view of a display apparatus according to a fourth embodiment of the disclosure. Referring to FIG. 6, the difference between a display apparatus 10C of the embodiment and the display apparatus 10B of FIG. 4 lies in that the anti-peep module 100C of the display apparatus 10C further includes a water vapor barrier film 150. More specifically, in the embodiment, the water vapor barrier film 150 is disposed on one side of the third polarizer POL3 facing away from the fourth substrate SUB4, and a material of the water vapor barrier film 150 includes, for example, polyethylene terephthalate (PET), polymethyl methacrylate (PMMA), or cyclic olefin polymer (COP).

Through the configuration of the water vapor barrier film 150, in addition to enhancing the water vapor resistance of the anti-peep module 100C, it can also reduce the contraction or expansion stresses generated in the third polarizer POL3 under cold, hot or high humidity environments, thereby preventing the thinned anti-peep module 100C from deforming and affecting the flatness and integrity of its structure. From another point of view, the provision of the water vapor barrier film 150 may effectively enhance the environmental durability of the thinned anti-peep module 100C, thereby improving the operational reliability of the display apparatus 10C in high temperature environment or thermal shock conditions.

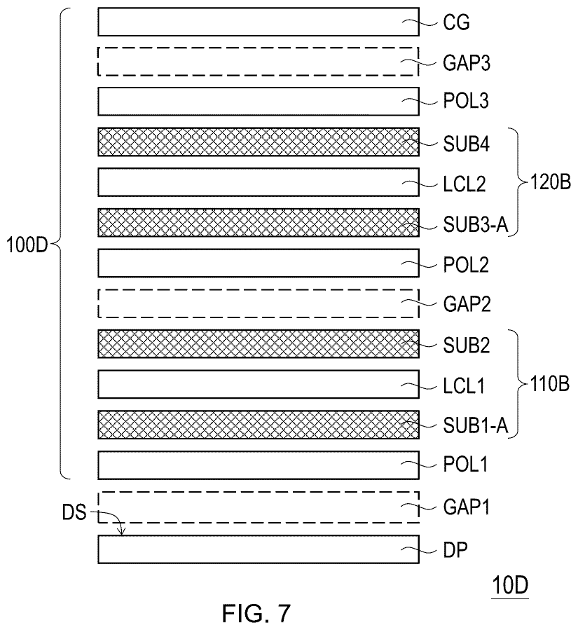

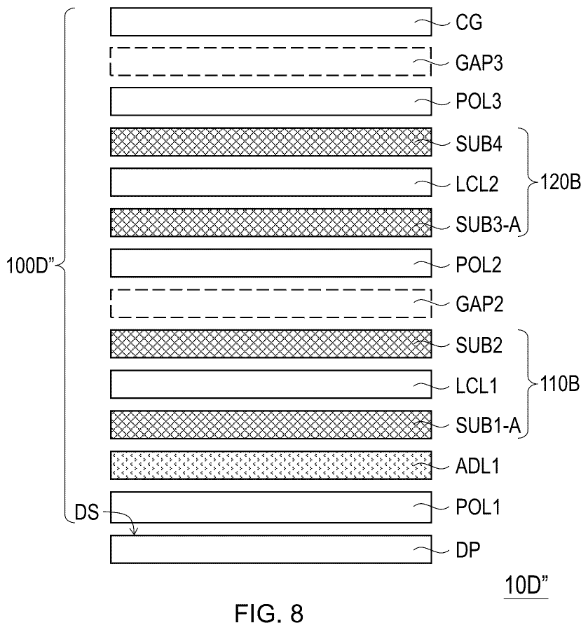

FIG. 7 is a schematic cross-sectional view of a display apparatus according to a fifth embodiment of the disclosure. FIG. 8 is a schematic cross-sectional view of another modified embodiment of the display apparatus of FIG. 7. Referring to FIG. 7, the difference between a display apparatus 10D of the embodiment and the display apparatus 10B of FIG. 4 lies in that the anti-peep module 100D of the display apparatus 10D further includes a glass cover CG. More specifically, in the embodiment, the glass cover CG is disposed on one side of the third polarizer POL3 facing away from the fourth substrate SUB4, and the glass cover CG is, for example, fixed to the third polarizer POL3 in an air bond manner. That is, a third gap GAP3 may be provided between the glass cover CG and the third polarizer POL3.

Since the anti-peep module 100D is disposed above the display panel DP and is susceptible to being pressed by users or external forces, the installation of the glass cover CG may avoid the problem of abnormal display, such as shadows (mura) on the screen, caused by excessive pressing on the anti-peep module 100D.

On the other hand, in the embodiment, both the bonding of the first viewing angle switching device 110B and the second viewing angle switching device 120B and the bonding of the anti-peep module 100D and the display panel DP are implemented in an air bond manner. That is, a first gap GAP1 is provided between the first substrate SUB1-A of the anti-peep module 100D and the display panel DP, and the first gap GAP1 exists between the first polarizer POL1 and the display panel DP. A second gap GAP2 is provided between the second substrate SUB2-A of the first viewing angle switching device 110B and the third substrate SUB3-A of the second viewing angle switching device 120B, and the second gap GAP2 exists between the second polarizer POL2 and the second substrate SUB2-A. However, the disclosure is not limited thereto. In another modified embodiment, as shown in FIG. 8, the first polarizer POL1 of the anti-peep module 100D″ of the display apparatus 10D″ may be directly attached to the display panel DP, and the anti-peep module 100D″ is bonded to the display panel DP in a direct bond manner. That is, a first adhesive layer ADL1 may be provided between the first substrate SUB1-A of the anti-peep module 100D″ and the display panel DP.

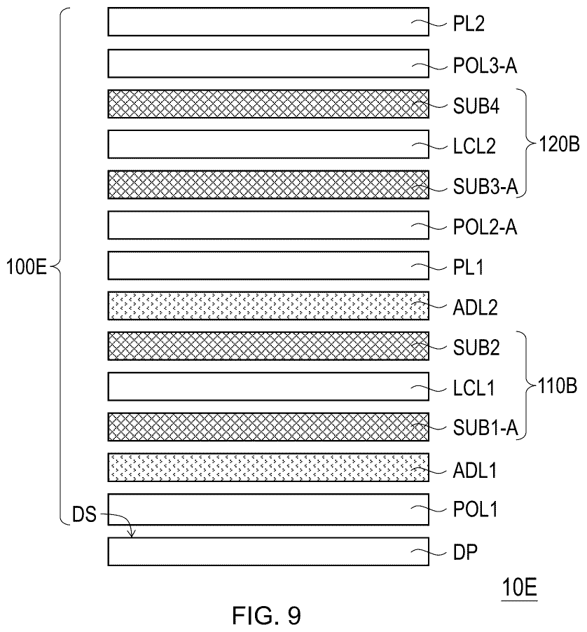

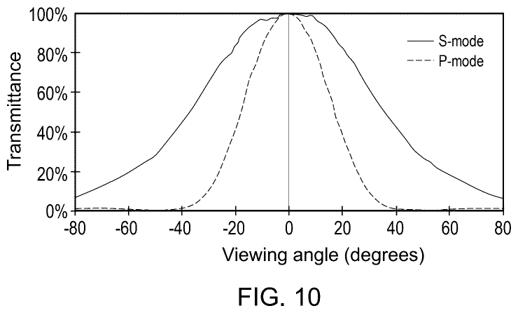

FIG. 9 is a schematic cross-sectional view of a display apparatus according to a sixth embodiment of the disclosure. FIG. 10 shows distribution curves of transmittance versus viewing angle for the display apparatus in FIG. 9 operating in a sharing mode and an anti-peep mode. Referring to FIG. 9, the main difference between a display apparatus 10E of the embodiment and the display apparatus 10B of FIG. 4 lies in that the types of the second polarizer and the third polarizer are different.

Specifically, in the embodiment, the materials of the second polarizer POL2-A and the third polarizer POL3-A may include lyotropic liquid crystals (LLC) or reactive mesogen liquid crystals (RMLC), and formed on the third substrate SUB3-A and the fourth substrate SUB4 by coating. In other words, the second polarizer POL2-A and the third polarizer POL3-A also eliminate the need for the substrate commonly used in current polarizers. Accordingly, the overall thickness and weight of the anti-peep module 100E may be further reduced.

FIG. 10 shows the distribution curves of transmittance versus viewing angle of the anti-peep module 100E of the embodiment operating in the sharing mode (S-mode) and the anti-peep mode (P-mode) respectively. As shown in FIG. 2B and FIG. 10, the anti-peep performance of the thinned anti-peep module 100E is still equivalent to the anti-peep performance of the anti-peep module of the comparative example (i.e., the thickness is not thinned). In other words, the thinned anti-peep module 100E may still maintain good anti-peep performance.

On the other hand, since the second polarizer POL2-A and the third polarizer POL3-A omit the installation of traditional substrates, the contraction or expansion stresses generated in the second polarizer POL2-A and the third polarizer POL3-A in high temperature environment or thermal shock conditions may be significantly reduced. More specifically, the second polarizer POL2-A and the third polarizer POL3-A of the embodiment may be stress-free polarizers.

In order to prevent the stress-free polarizers from being damaged by unexpected external forces, the anti-peep module 100E of the embodiment is further provided with a first protective layer PL1 on one side of the second polarizer POL2-A facing away from the third substrate SUB3-A, and a second protective layer PL2 on one side of the third polarizer POL3-A facing away from the fourth substrate SUB4. However, the disclosure is not limited thereto. In another modified embodiment, the second polarizer POL2-A may be formed on the second substrate SUB2.

Therefore, the first protective layer PL1 may be disposed on one side of the second polarizer POL2-A facing away from the second substrate SUB2.

To sum up, in the display apparatus according to an embodiment of the disclosure, at least two substrates of the anti-peep module each have birefringence. Therefore, in addition to enhancing anti-peep effect, it can also effectively reduce the overall thickness and weight of the anti-peep module, thereby improving the portability of the display apparatus and its design flexibility in product applications.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display apparatus, comprising:
a display panel, having a display surface; and
an anti-peep module, disposed on one side of the display surface of the display panel and overlapping the display surface, and the anti-peep module includes:
a first substrate, a second substrate, a third substrate and a fourth substrate, overlapped with each other;
a first liquid crystal layer, disposed between the first substrate and the second substrate;
a second liquid crystal layer, disposed between the third substrate and the fourth substrate;
a first polarizer, disposed between the first substrate and the display panel;
a second polarizer, disposed between the second substrate and the third substrate; and
a third polarizer, disposed on one side of the fourth substrate facing away from the third substrate, wherein at least two of the first substrate, the second substrate, the third substrate and the fourth substrate each have birefringence.

2. The display apparatus according to claim 1, wherein a material of each of the first substrate, the second substrate, the third substrate and the fourth substrate has birefringence and includes tri-acetyl cellulose.

3. The display apparatus according to claim 2, wherein a thickness of each of the first substrate, the second substrate, the third substrate and the fourth substrate is greater than or equal to 20 microns and less than or equal to 80 microns.

4. The display apparatus according to claim 2, wherein the anti-peep module further includes:
a water vapor barrier film, disposed on one side of the third polarizer facing away from the fourth substrate, and a material of the water vapor barrier film includes polyethylene terephthalate, polymethyl methacrylate or cyclic olefin polymer.

5. The display apparatus according to claim 2, wherein the anti-peep module further includes:
a glass cover, disposed on one side of the third polarizer facing away from the fourth substrate.

6. The display apparatus according to claim 2, wherein a material of the second polarizer and the third polarizer includes lyotropic liquid crystals or reactive mesogen liquid crystals.

7. The display apparatus according to claim 6, wherein the second polarizer is formed on one of the second substrate and the third substrate, the third polarizer is formed on the fourth substrate, a first protective layer is provided on one side of the second polarizer facing away from the one of the second substrate and the third substrate, and a second protective layer is provided on one side of the third polarizer facing away from the fourth substrate.

8. The display apparatus according to claim 1, wherein materials of one of the first substrate and the second substrate and one of the third substrate and the fourth substrate include glass, material of the other of the first substrate and the second substrate and the other of the third substrate and the fourth substrate include tri-acetyl cellulose, a sum of thicknesses of the first substrate and the second substrate is less than or equal to 200 microns, and a sum of thicknesses of the third substrate and the fourth substrate is less than or equal to 200 microns.

9. The display apparatus according to claim 8, wherein the anti-peep module further includes:
a first glass substrate, disposed between the first liquid crystal layer and the second substrate; and
a second glass substrate, disposed between the second liquid crystal layer and the fourth substrate.

10. The display apparatus according to claim 1, wherein a first adhesive layer or a first gap is provided between the first substrate and the display panel, and a second adhesive layer or a second gap is provided between the second substrate and the third substrate.
